(19) United States
(12) Patent Application Publication
(10) Pub. No.: US 2005/0010322 A1
(43) Pub. Date: Jan. 13, 2005

(54) Dyeing system, and embroidering and dyeing system

(75) Inventors: Hisaharu Goto, Nagoya-shi (JP); Seiichiro Hagino, Chiryu-shi (JP); Mikio Furuichi, Kuwana-shi (JP); Tsukasa Ando, Nishikasugai-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 10/887,848

(22) Filed: Jul. 12, 2004

(30) Foreign Application Priority Data
Jul. 11, 2003 (JP) 2003-196027

(51) Int. Cl. G06F 19/00

(52) U.S. Cl. 700/132

(57) ABSTRACT

A dyeing system includes a frame, an arm configured to be extended from the frame, a shaft portion rotatably projected from the frame, a movable body provided at the shaft portion to be movable in an axial direction and to be unitarily rotatable, a first support body including an internal space inserted with the shaft portion, a connection body for connecting the first support body and the movable body, a second support body detachably provided at the first support body for supporting a work piece including a cylindrical portion, a first drive mechanism for rotating the shaft portion, a second drive mechanism for moving the first support body or the shaft in the axial direction of the shaft portion, and an ink jet mechanism provided in the arm for jetting ink for dyeing the work piece supported at the first support body.

### CROSS REFERENCE TO RELATED APPLICATIONS

This application is based on and claims priority under 35 U.S.C. §119 with respect to Japanese Patent Application No. 2003-196027 filed on Jul. 11, 2003, the entire content of which is incorporated herein by reference.

### FIELD OF THE INVENTION

The present invention relates to a dyeing system, and an embroidering and dyeing system. More particularly, the present invention pertains to a dyeing system, and an embroidering and dyeing system for embroidering or/and dyeing on a cylindrical work piece.

### BACKGROUND

A known embroidering and dyeing system for embroidering and dyeing on a work piece (primarily on cloth) is described in Japanese Patent Laid-Open Publication No. H05-272046. With the construction of the known embroidering and dyeing system described in Japanese Patent Laid-Open Publication No. H05-272046, the work piece to be embroidered and dyed is limited to a work piece tensioned in plane and the known embroidering and dyeing system is not applicable for embroidering and dyeing cylindrical work pieces.

A need thus exists for a dyeing system, and an embroidering and dyeing system which allows to dye, and to embroider and dye on the cylindrical work piece.

### SUMMARY OF THE INVENTION

In light of the foregoing, the present invention provides a dyeing system, a frame; an arm configured to be extended from the frame; a shaft portion rotatably projected from the frame; a movable body mounted on the shaft portion, the movable body being movable in an axial direction of the shaft portion, the movable body being capable of unitary rotation with the shaft portion; a first support body including an inner space into which the shaft portion extends; a connection body for connecting the first support body and the movable body; a second support body detachably coupled to the first support body for supporting a work piece including a cylindrical portion; a first drive mechanism for rotating the shaft portion; a second drive mechanism for moving the first support body in the axial direction of the shaft portion; and an ink jet mechanism provided in the arm for jetting ink for dyeing the cylindrical portion of the work piece supported at the first support body.

According to another aspect of the present invention, an embroidering and dyeing system an arm configured to be extended from the frame; a needle extended downward from an end portion of the arm; a bed projected from the frame; a sewing mechanism accommodated in the bed cooperating with the needle for sewing a work piece including a cylindrical portion; a shaft portion positioned below the bed to be in parallel with the bed; the shaft portion rotatably projected from the frame; a movable body mounted on the shaft portion, the movable body being movable in an axial direction of the shaft portion, the movable body being capable of unitary rotation with the shaft portion; a first support body including an inner space into which the shaft portion extends; a connection body for connecting the first support body and the movable body; a second support body detachably coupled to the first support body for supporting a work piece including a cylindrical portion; a first drive mechanism for rotating the shaft portion; a second drive mechanism for moving the first support body in the axial direction of the shaft portion; and an ink jet mechanism provided in the arm for jetting ink for dyeing cylindrical portion of the work piece supported at the first support body.

According to a still another aspect of the present invention, a dyeing system includes: holding means for holding a cylindrical work piece; moving means for moving the frame cylindrical work piece in any direction; and ink jetting means for dyeing cylindrical work piece which is in motion.

### BRIEF DESCRIPTION OF THE DRAWINGS

The foregoing and additional features and characteristics of the present invention will become more apparent from the following detailed description considered with reference to the accompanying drawings, wherein:

FIG. 1 shows a perspective view of an embroidering and dyeing system according to an embodiment of the present invention.

FIG. 2 shows a cross-sectional view of a main portion of the embroidering and dyeing system according to the embodiment of the present invention.

FIG. 3 shows a front view of a supporting portion according to the embodiment of the present invention.

FIG. 4 shows a state that a cylindrical work piece is positioned at the supporting portion according to the embodiment of the present invention.

### DETAILED DESCRIPTION OF THE PRESENT INVENTION

An embodiment of the present invention will be explained with reference to the illustrations of the drawing figures as follows.

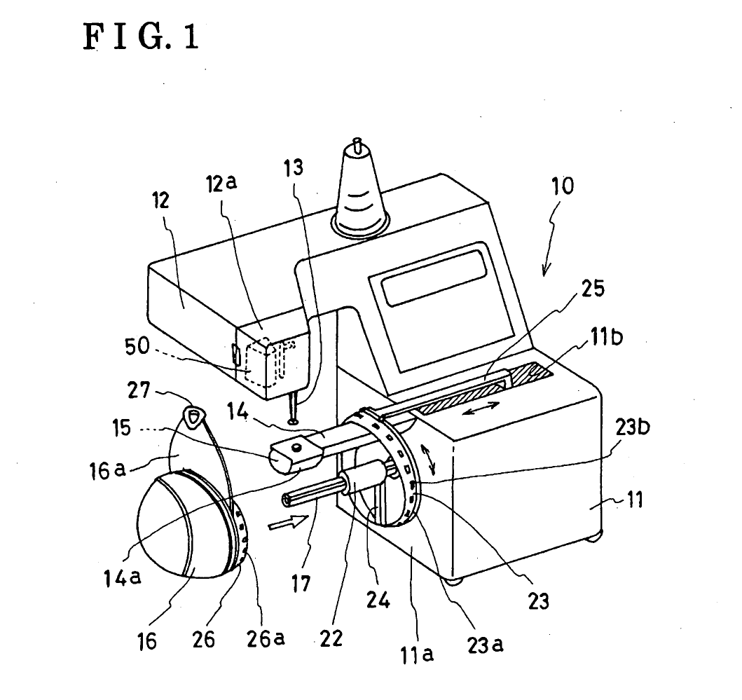

As shown in FIGS. 1 through 4, an embroidering and dyeing system 10 includes a frame 11. An arm 12 is extended from the frame 11. A needle 13 is provided at an end portion of the arm 12 to be extended therefrom downward. The needle 13 cooperates with a sewing mechanism 15 provided inside a distal end portion of a bed 14 projected from the frame 11 to make one or more embroiders on a cylindrical work piece 16, for example, a cap. The sewing mechanism 15 includes a shuttle, a looper, and other related members (all are not shown). Due to the fact that the structure of the sewing mechanism 15, no further explanation thereof will be made.

A spline shaft 17 projects from a side surface 11a of the frame 11 to be in parallel with the bed 14 below the bed 14. A base portion of the spline shaft 17 is rotatably supported by a bearing 18 fixed in the side surface 11a and is provided with a pulley 19 in the frame 11. A timing belt 19 is tensioned between the pulley 19 and pulley 21 fixedly mounted on a shaft 20a of a motor 20. When the motor 20 is turned on, the resulting rotation of the shaft 20a is transmitted by way of the pulley 21, the timing belt 29, and the pulley 19 to the spline shaft 17, thereby rotating the spline shaft 17.

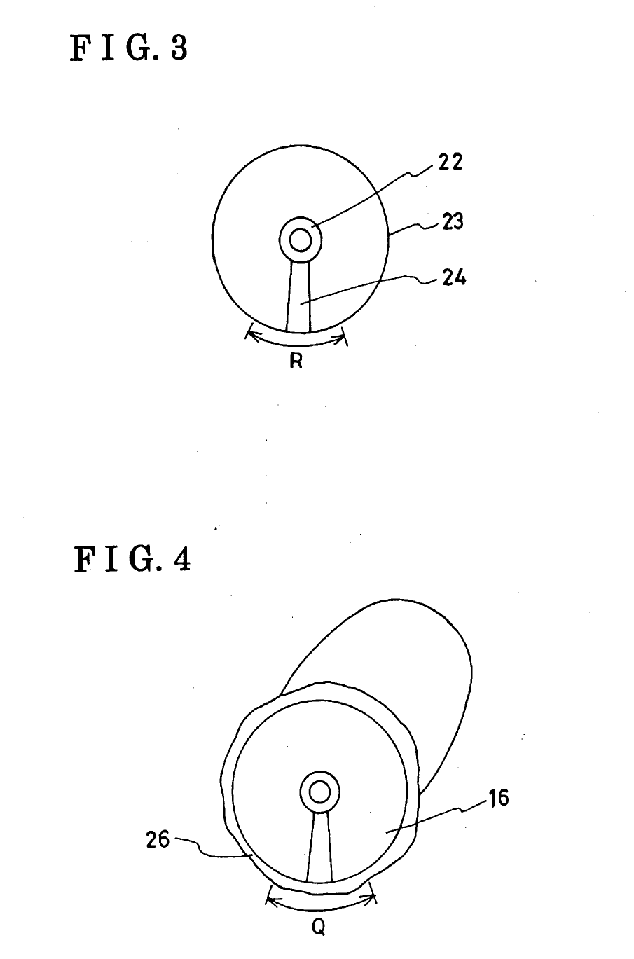

A movable body 22 is provided on the spline shaft 17. The movable body 22 is movable on the spline shaft 17 in the axial direction thereof and rotates together with the spline shaft 17. Within an inner peripheral portion of an annular first support body 23, there are positioned the spline shaft 17, the bed 14 and the movable body 22. The inner peripheral portion of an annular first support body 23 is connected to the movable body 22 via a connection body 24. The first support body 23 is arranged to be in co-axial alignment with the spline shaft 17 and is made to be in unitary rotation with the spline shaft 17. In order to avoid a collision or an interference between the connection body 24 and the arm 14, a range R is defined on which no embroideries are made by controlling the motor 20 (shown in FIG. 3).

An annular flange 23a is formed at an external periphery of the first support body 23. The annular flange 23a is positioned in an inner peripheral groove 25a formed in a distal end of a bracket 25 extended from the inside of the frame 11 via a slot 11b configured to be rectangular, or the like, formed on the frame 11. With the foregoing construction, the interference between the first support body 23 and the bracket 25 can be avoided even when the first support body 23 rotates.

The base portion of the bracket 25 is connected to a timing belt 30 provided or tensioned between a pulley 36 and a pulley 28 rotated by the motor 31. Upon movement of the bracket 25 caused by the motor 31 which is in active, the annular flange 23a of the first support body 23 is brought into engagement with the inner peripheral groove 25a at the distal end of the bracket 25, thereby moving the first support body 23 in the axial direction.

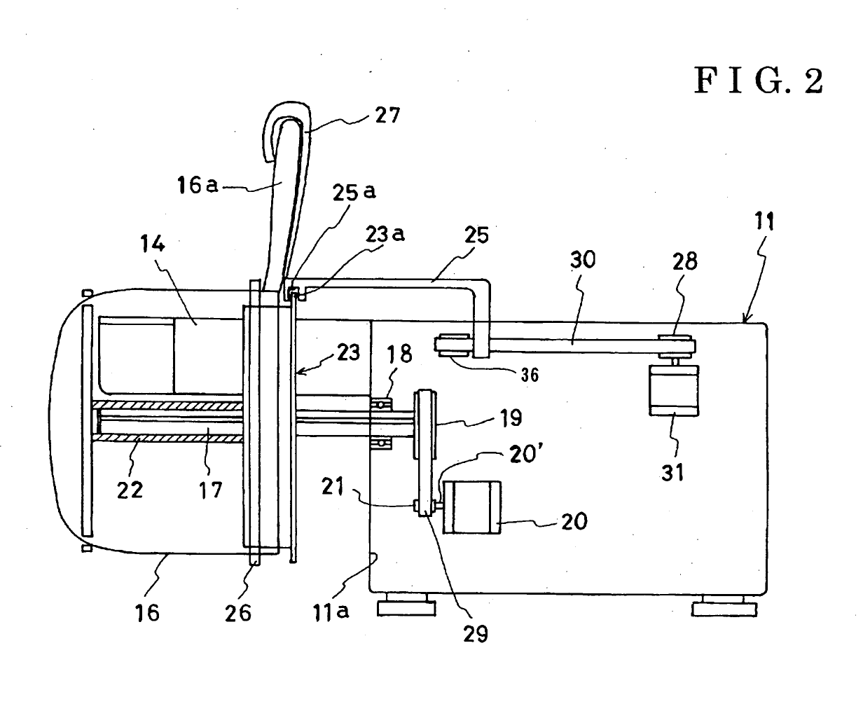

A second support portion 26 is configured to support or hold the cylindrical work piece 16. When the cylindrical work piece 16 which is in the form of a cap, for example, is supported at the second support portion 26, a holder portion 27 extends in the radiauy outwardly direction by a predetermined length and thereafter bends inward supports or hold a brim of the cylindrical work piece 16. A plurality of equally-spaced holes 26a are formed in the peripheral portion of the second support body 26. The second support body 26 is connected to the first support body 23 by engaging the holes 26a with projections 23b formed in the outer periphery of the first support body 23 (shown in FIG. 2).

Thus, with the construction of the embroidering and dyeing system 10, as shown in FIG. 2, the movement of the needle 13 synchronizes with the unitary rotation of the spline shaft 17, the movable body 22, the connection body 24, the first support body 23, and the second support body 26. Thus, the needle 13 and the sewing mechanism 15 operate to embroider the cylindrical work piece 16. The position of the needle 13 is set above the portion of the work piece to be embroidered by moving the movable body 22 and the spline shaft 17 in the axial direction.

A portion Q which is not to be embroidered (shown in FIG. 4) is corresponded with the range R (shown in FIG. 3) which is not to be embroidered.

An inkjet mechanism 50 is provided in the end portion of the arm 12. The ink-jet mechanism 50 jets the ink for dyeing the cylindrical work piece 16. The inkjet mechanism 50 operates to dye the cylindrical work piece 16 when the sewing mechanism 15 is not operated.

Likewise the embroidering operation, with the construction of the embroidering and dyeing system 10, as shown in FIG. 2, the operation of the ink jet mechanism 50 synchronizes with the unitary rotation of the spline shaft 17, the movable body 22, the connection body 24, the first support body 23, and the second support body 26 to dye the cylindrical work piece 16. The position of the ink jet mechanism 50 is set above the portion of the work piece to be dyed by moving the movable body 22 and the spline shaft 17 in the axial direction.

The ranges for the embroidering and the dyeing are determined by the moving amount in the R direction and in the X direction of the first support body 23 supporting the cylindrical work piece 16.

The sewing mechanism 15, the needle 13, and the mechanism related to the needle 13 may be removed to function as the dyeing system.

According to the embodiment of the present invention, the dyeing can be provided at the cylindrical work piece and the dyeing and the embroidering can be provided at the cylindrical work piece.

The principles, preferred embodiments and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A dyeing system comprising:
a frame;
an arm configured to be extended from the frame;
a shaft portion rotatably projected from the frame;
a movable body mounted on the shaft portion, the movable body being movable in an axial direction of the shaft portion, the movable body being capable of unitary rotation with the shaft portion;
a first support body including an inner space into which the shaft portion extends;
a connection body for connecting the first support body and the movable body;
a second support body detachably coupled to the first support body for supporting a work piece including a cylindrical portion;
a first drive mechanism for rotating the shaft portion;
a second drive mechanism for moving the first support body in the axial direction of the shaft portion; and
an ink jet mechanism provided in the arm for jetting ink for dyeing the cylindrical portion of the work piece supported at the first support body.

2. An embroidering and dyeing system comprising:
a frame;
an arm configured to be extended from the frame;
a needle extended downward from an end portion of the arm;
a bed projected from the frame;
a sewing mechanism accommodated in the bed cooperating with the needle for sewing a work piece including a cylindrical portion;
a shaft portion positioned below the bed to be in parallel with the bed; the shaft portion rotatably projected from the frame;
a movable body mounted on the shaft portion, the movable body being movable in an axial direction of the shaft portion, the movable body being capable of unitary rotation with the shaft portion;
a first support body including an inner space into which the shaft portion extends;
a connection body for connecting the first support body and the movable body;
a second support body detachably coupled to the first support body for supporting a work piece including a cylindrical portion;
a first drive mechanism for rotating the shaft portion;
a second drive mechanism for moving the first support body in the axial direction of the shaft portion; and
an ink jet mechanism provided in the arm for jetting ink for dyeing cylindrical portion of the work piece supported at the first support body

3. A dyeing system comprising:
holding means for holding a cylindrical work piece;
moving means for moving the frame cylindrical work piece in any direction; and
ink jetting means for dyeing cylindrical work piece which is in motion.
